(19) United States
(12) Patent Application Publication
(10) Pub. No.: US 2010/0097193 A1
(43) Pub. Date: Apr. 22, 2010

(54) LIFESTYLE MANAGEMENT SYSTEM AND METHOD

(75) Inventor: Paul C. Tang, Los Altos, CA (US)

Correspondence Address: Dorsey & Whitney LLP;Intellectual Property Department - SF, Columbia Center, 701 Fifth Avenue, Suite 6100, Seattle, WA, 98101-7043, US

(73) Assignee: Palo Alto Medical Foundation, Mountain View, CA (US)

(21) Appl. No.: 12/255,796

(22) Filed: Oct. 22, 2008

(51) Int. Cl. H04Q 5/22

(52) U.S. Cl. 340/10.4

(57) ABSTRACT

A system for use by a person to evaluate an edible item having a nutritional content is provided. The edible item is associated with a menu. The system includes an RFID tag associated with the menu and encoded with information regarding at least a portion of the nutritional content of the edible item. The system also includes a portable electronic device including an RFID tag reader and a display, the RFID tag reader being configured to obtain the information regarding at least the portion of the nutritional content encoded by the RFID tag and display at least a portion of the obtained information from the RFID tag on the display. Automated feedback may also be provided based on predetermined lifestyle plan including nutritional goals, to aid the person in evaluating the edible item.

### TECHNICAL FIELD

This invention relates to systems and methods for tracking compliance with a lifestyle plan, and in particular to systems and methods for aiding a person in selecting among choices on a menu and performing physical activity.

### BACKGROUND OF THE INVENTION

The United States' and world populations are increasingly overweight, which may lead to an increased risk of adverse health consequences such as diabetes mellitus, cardiovascular disease, hypertension, arthritis, and other chronic diseases, with its attendant healthcare costs and lost productivity. In 2004, over 66% of Americans were either overweight or obese; 32% were obese. The trends continue to rise with increasing numbers of Americans becoming obese. As many as 30% of American teenagers are overweight, a concerning trend that may portend significant morbidity for future Americans. Although public education and media appeals are drawing the public's attention to this problem, few tools are available to help individuals make wise choices about their nutritional intake and level of physical activity. Even when tools are available, they are rarely used unless they are convenient, inexpensive, and fun.

For example, to accurately track nutritional intake, a user needs to record accurate nutritional information regarding the items they consume. This information may be cumbersome for the user to record. For example, the user may be required to manually report nutritional information obtained from food packaging to assess compliance with their lifestyle program. In situations where a user consumes food outside of the home, such as in a restaurant, nutritional information may be unavailable, or must be manually obtained from printed information provided by the restaurant, or accessed at a later time from the restaurant's web site.

Further, even if a user is able to accurately track their nutritional intake, it may be cumbersome or difficult to obtain feedback and advice about their adherence to their nutritional goals or plan. When working with a health professional, for example, the user may need to meet with the professional to assess their progress. This delayed feedback after the fact may not be effective at changing a user's behavior at the point of decision—when they are actually making a decision about what food to consume.

### SUMMARY OF ASPECTS OF THE INVENTION

In one aspect of the present invention, a system for use by a person to evaluate an edible item is provided. The edible item has a nutritional content and is associated with a menu. The system includes an RFID tag associated with the menu and encoded with information regarding at least a portion of the nutritional content of the edible item. The system also includes a portable electronic device including an RFID tag reader and a display. The RFID tag reader is configured to obtain the information regarding at least the portion of the nutritional content encoded by the RFID tag and display at least a portion of the obtained information from the RFID tag on the display to aid the person in evaluating the edible item.

In another aspect of the present invention, an electronic device for use by a person and with an RFID tag encoded with nutritional information regarding an edible item on a menu associated with the RFID tag. The electronic device includes an RFID tag reader configured to obtain the nutritional information from the RFID tag. The electronic device also includes a display coupled to the RFID tag reader configured to display the nutritional information to aid the person in evaluating the edible item.

In another aspect of the present invention, a computer program product for aiding a person in selecting an edible item from a menu is provided. The menu is associated with an RFID tag encoded with nutritional information regarding the edible item. The computer program product includes a computer readable memory encoded with a plurality of instructions that, when executed, cause a processor to perform functions including to obtain the nutritional information from the RFID tag, display the nutritional information to the person, upload the nutritional information to a computing device, receive feedback information from the computing device based in part on the uploaded information and a lifestyle plan for the person, and display at least a portion of the feedback information to assist the person.

In another aspect of the present invention, a computer program product for aiding a person in selecting an edible item from a menu of a plurality of edible items is provided.

The menu is associated with an RFID tag encoded with nutritional information regarding the edible item. The computer program product includes a computer readable memory encoded with a plurality of instructions that, when executed, cause a processor to receive nutritional information regarding the edible item, access a lifestyle plan associated with the person, compare the received nutritional information with the accessed lifestyle plan, and transmit feedback information to the person based on the comparison.

In another aspect of the present invention, a system for aiding a person in selecting from among a plurality of edible items is provided. The plurality of edible items are associated with one or more RFID tags encoded with nutritional information regarding the edible items. The system includes a database storing a lifestyle plan for the person and lifestyle plans for other persons and a receiver configured to receive from the person nutritional information stored on the one or more RFID tags pertaining to one of the plurality of edible items. The system also includes a processor coupled to the receiver and configured to access the lifestyle plan for the person, compare the lifestyle plan with the received nutritional information and formulate feedback information. The system also includes a transmitter coupled to the processor and configured to transmit the feedback information to the person.

In another aspect of the present invention, a method for use by a person to comply with a lifestyle plan, the person in proximity to an RFID tag associated with a menu having a plurality of edible items is provided. The RFID tag has nutritional information with respect to at least one of the plurality of edible items. The method includes scanning the RFID tag to obtain nutritional information for at least one of the plurality of edible items; and uploading the nutritional information to a lifestyle management server. The method also includes receiving feedback information from the lifestyle management server based on a comparison of the lifestyle plan with the nutritional information and selecting at least one of the plurality of edible items for consumption based in part on the feedback information.

### BRIEF DESCRIPTION OF THE DRAWINGS

FIG. 1 is a schematic illustration of a system according to an embodiment of the present invention.

FIG. 2 is a schematic illustration of the personal mobile device of FIG. 1 according to an embodiment of the present invention.

### DETAILED DESCRIPTION

Certain details are set forth below to provide a sufficient understanding of embodiments of the invention. However, it will be clear to one skilled in the art that embodiments of the invention may be practiced without various of these particular details. In some instances, well-known circuits, control signals, timing protocols, computer systems, and software operations have not been shown in detail in order to avoid unnecessarily obscuring the described embodiments of the invention.

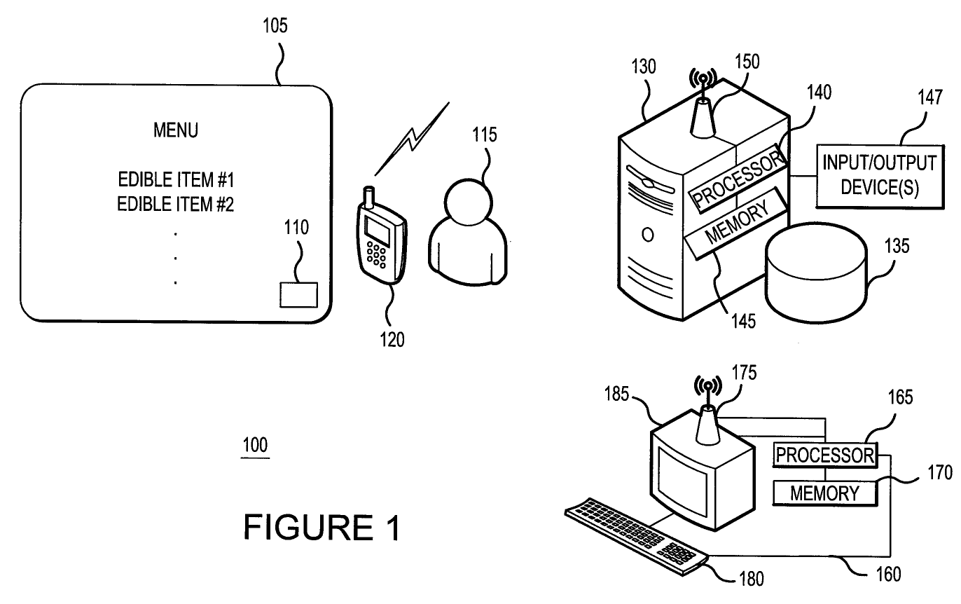

FIG. 1 depicts one embodiment of a system 100 of the present invention. A menu 105 is associated with a radio frequency identification (RFID) tag 110. The menu 105 lists a plurality of edible items for consideration by a person 115. The RFID tag 110 encodes nutritional information for each of the edible items on the menu 105. Although a single RFID tag 110 is shown encoding nutritional information for a plurality of edible items, in other embodiments, a plurality of RFID tags may be provided, each encoding information for one or more of the edible items on the menu 105. Furthermore, although a single menu 105 is shown as a visual display in FIG. 1, the menu in other embodiments may include any kind of food listing, including a plurality of placards placed alongside a food item, such as placards along a buffet line in a restaurant or cafeteria. In still other embodiments, an RFID tag 110 may be provided on the packaging of an edible item.

RFID tags according to the present invention may encode nutritional information for any type of edible item ranging from a raw ingredient to a prepared meal or an advertised combination, for example a lunch or other special or a value meal. Nutritional information encoded by the RFID tag may generally include any aspect of the nutritional content of the item including, but not limited to calorie count, carbohydrates, total fat, saturated fat, trans fat, sugar, protein, fiber, sodium, potassium, and any other vitamin or mineral content. Further, the nutritional information may include information for a particular diet plan—such as WEIGHT WATCHERS® points. The RFID tag information may be standardized nutritional content as regulated by the Food and Drug Administration.

RFID tags used in embodiments of the present invention generally include an RFID circuit that may be programmed with coded textual fields and interpreted by appropriate software. Generally, any RFID tag may be used and programmed with nutritional information for the associated edible items. The RFID tag may contain an adhesive backing for ease of placement on a physical menu. The RFID tag may, however, be associated with the menu in generally any manner, including placement on or in the vicinity of the menu.

The person 115 obtains information from the RFID tag 110 using any available RFID tag reader. In some embodiments, the restaurant or location providing the RFID tag 110 may also provide a tag reader for users to scan the RFID tag 110. As shown in FIG. 1, the person 115 may use a personal mobile device 120 to obtain nutritional information from the RFID tag 110. The personal mobile device may be any suitable portable electronic device carried by the person 115 during the course of their everyday life, such as a cell phone, personal data assistant or music player. Generally, any portable device having a processor, memory and display capabilities may be equipped with an RFID tag reader and used in accordance with embodiments of the present invention. The personal mobile device 120 includes an RFID tag reader to obtain information from the RFID tag 110. The personal mobile device 120 also includes a transmission device for uploading information to a remote electronic device using any available communications protocol, including for example cellular technology or wireless networking technology.

While a personal mobile device 120 is shown in FIG. 1, in other embodiments, a fixed electronic device, such as a computer or a kiosk, may be provided at the location having the menu 105. In such an embodiment, the person 115 may log in to the provided kiosk and obtain and upload information in much the same way as described with respect to the personal mobile device 120, except the kiosk would not depart the location with the user.

The personal mobile device 120 may communicate with a second electronic device, such as server or computer 130. The server 130 may receive, for example, a portion of the nutritional information encoded by the RFID tag 110 and obtained by the personal mobile device 120, as will be described further below. In some embodiments, it is the server 130 that may translate coded information read from the RFID tag 110 into a measure of nutritional content. The coded information may be decoded in a variety of ways, including for example, a table lookup. In other embodiments, this translation function may be performed by the personal mobile device 120. The server 130 may be in communication with a database 135 for storage of received nutritional information associated with one or a plurality of users. The server 130 includes a processor 140 and a memory 145 for executing lifestyle management software, as will be described further below. The server 130 may also include one or more input or output devices 147 for administering the server 130 or for the person 115 to input or review their lifestyle plan, as described further below. The server 130 is also in communication with a transmitter and receiver 150 for communication with the personal mobile device 120. Generally, the database 135 or memory 145 contains a stored lifestyle plan for the person 115. When the server receives nutritional information about an edible item selection from the person 115, the server 130 may compare the selection with the user's lifestyle plan and transmit feedback information to the personal mobile device 120. By transmitting the feedback information to the person 115 at the user's point of decision, the person 115 may be able to change their selection based on the feedback from the lifestyle management software. The feedback information my be supplied by any type of communication including email, SMS text message, network transmission, or other secure messaging methods. The server 130 may generally reside in any location, including at a health provider or insurer or a lifestyle management company location.

Further, once nutritional information from the person 115 is stored in the database 135, it may be accessed by the user in other locations, such as by a third electronic device 160 which may be, for example, at the user's work or home. The third electronic device 160 also includes a processor 165 and a memory 170, a transmitter and receiver 175, and input and output devices such as a keyboard 180 and display 185. The person 115 may receive information from the server 130 regarding their consumption and performance according to their lifestyle plan, as will be described further below.

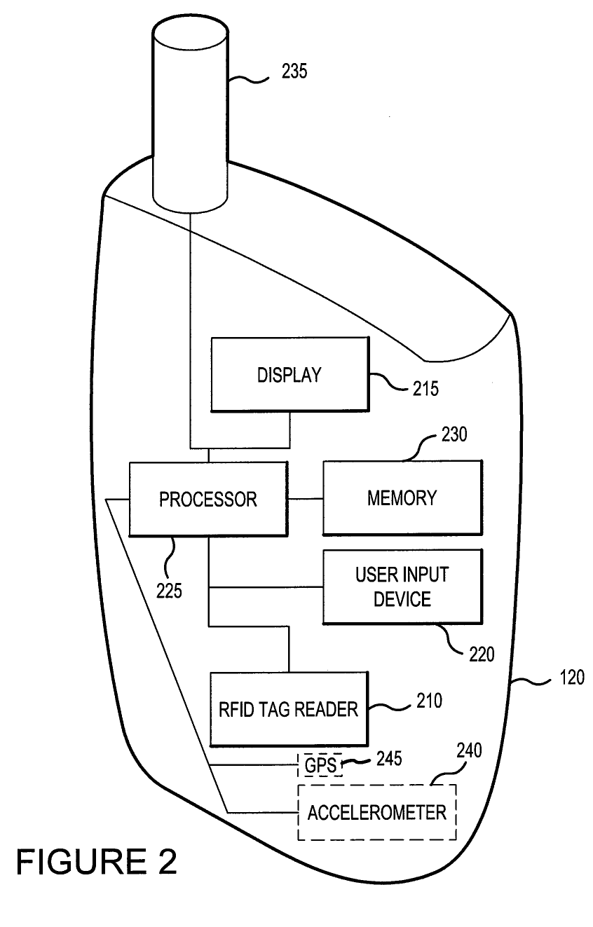

An example of the personal mobile device 120 is shown in FIG. 2. The personal mobile device 120 includes an RFID tag reader 210 for obtaining the nutritional information from the RFID tag 110 in FIG. 1. The personal mobile device 120 further includes a display 215 for displaying messages and the like to the person 115. As described further below, the display 215 may display all or a portion of the nutritional information obtained from the RFID tag 110. The personal mobile device 120 further includes a user input device 220, such as a button, touch screen, keyboard, scroll wheel, or the like. The user input device 220 allows the user to make selections and provide other input, as described below. The user input device 120 further includes a processor 225 and a memory 230. The memory 230 may store software including instructions causing the processor 225 to perform certain functionalities, as described further below. The personal mobile device 120 also includes a transmitter and receiver 235 for communicating with another electronic device using, for example, cellular or wireless networking technology. The personal mobile device 120 may also include an accelerometer 240 and GPS 245 for providing a measure of physical activity of the user, such as a distance traveled, or a number of steps taken. The measure of physical activity may also be transmitted to the server 130 and used to compare the user's performance to their lifestyle plan. The server 130 may also track the amount of physical activity performed by the user over time.

The personal mobile device 120 may include client software able to assist a user at the point of decision-making regarding their choice of edible items from the menu 105 and compliance with a lifestyle plan that may be personalized for them. Accordingly, the personal mobile device 120 may process the nutrition information read by the RFID reader from the RFID tag 110 and may parse the information for display to the person 115. The user input device 220 may allow a user to select nutritional information related to a selected one or more of the edible items on the menu 105 for upload to a server. The user input device 220 may further allow a user to upload the selected items to the server. For example, the personal mobile device 120 may include an ‘upload’ button or menu selection causing all marked items to be uploaded. The client software on the personal mobile device 120 may also process incoming transmissions, such as network transmissions, short messaging service (SMS) messages, or the like, to identify messages intended to be processed by the client software and react to the messages, to for example, display an alert message or produce an alert tone. Example messages include feedback on a selected edible item, update about the user's cumulative nutritional intake compared to their lifestyle plan, or feedback on a measure of activity received.

Lifestyle management software operating on the server 130 may receive transmitted data from the user's mobile device 120 and compare the information with the user's lifestyle plan. Accordingly, an identification of the person 115 may be transmitted along with the nutritional information. The identification of the person 115 may include a user name, or may simply be an identification of the user's personal mobile device 120, such as a cell phone number. Based on the identification of the user, the server 130 may access the user's lifestyle plan and formulate feedback information regarding the user's potential selection, and store the user's final selections for later review. For example, the lifestyle management software may track nutritional intake based on selected edible items identified by the user's personal mobile device. Graphical feedback may be provided to the person 115 and can, for example, provide feedback about a prospective food or activity choice based on the individual's health record or goals. A health provider, lifestyle coach, or other personnel, may also have access to the user's lifestyle plan and nutritional information stored in the database 135 and may use the information to consult with the person 115 on their progress or modify their goals in accordance with performance. Furthermore, the database 135 may store nutritional consumption and physical activity measures for other users in the system. Accordingly, the lifestyle management software may provide feedback to the person 115 regarding their performance in comparison with other users, or selected users, such as their family, support group, social network group, or the like. The ability to view a user's performance as compared with others can be a very motivating factor. The lifestyle management software may accordingly provide graphical views of the nutritional intake, activity level, or both, of the user in comparison with their personal goals, peer activity, or national or other benchmarks. The nutritional intake may be depicted by category (for example, carbohydrate, fat, saturated fat, trans fat, sodium, and the like). The uploaded nutritional intake data may be compared with goals and feedback information (such as a comparison of caloric intake versus goals) may be generated. Combining the received measures of physical activity with the nutritional information of edible items consumed by the person 115 may allow the lifestyle management software to estimate and communicate the caloric balance for the user on a daily or weekly basis, for example. The lifestyle management software may generate feedback information based on a comparison of uploaded nutritional information with the user's lifestyle plan, and the server 130 transmits the feedback information to the personal mobile device 120 for use by the user.

Accordingly, embodiments of the invention may be used to assist a user in selecting a menu item, or more generally, to assist a user in complying with a lifestyle plan. The server 130 will store the user's lifestyle plan for use in comparing the plan with the choices or proposed choices made by the person 115. The lifestyle plan may be developed in any of a variety of ways, including being directly input by the user or the user's health provider or coach. In one embodiment, the user answers a questionnaire and/or imports health information from an electronic health record or other health record system. Health information imported may include, for example, height, weight, age, disease history, current health conditions, and the like. Based on the health information obtained, the lifestyle management software may propose candidate nutritional goals for the user. The user, alone or in cooperation with a health provider or coach, may select or modify the nutritional and physical activity goals. The goals may include daily, weekly, or yearly limits on caloric intake, sugar intake, carbohydrate intake, or the like, as well as vitamin and mineral information and daily, weekly, or yearly, physical activity goals.

Based on selected goals, the lifestyle management software may formulate a lifestyle plan for the user, which may be graphically presented on, for example, a personalized web page. The lifestyle plan may also be downloaded to client software residing on the user's personal mobile device 120 or other electronic device, such as the electronic device 160 in FIG. 1.

A graphical representation of the lifestyle plan, including nutritional or physical activity goals, and cumulative progress, may be displayed on a summary page for the individual to access from their personal mobile device 120 or other electronic device 160. The cumulative information may be updated as the person 115 uploads nutritional information about consumed edible items or physical activity information. Furthermore, the user may modify their nutritional or physical activity goals.

As the user goes about their life, they may swipe their personal mobile device 120 over the RFID tag 110 to read the tag. The client software may read the RFID tag, parse the information encoded by the tag, and display the information for the user. For example, scanning the RFID tag may cause the personal mobile device 120 to display the nutritional content of the edible item as a SMS text message. In some embodiments, the person 115 has a particular health concern—for example carbohydrate intake. Accordingly, the client software may be alerted to this concern by the user's lifestyle plan and may display only the carbohydrate content of the edible item scanned, or highlight the sugar content in the display of nutritional information. The implications of consuming the edible item may thus be immediately presented to the user at the point of decision by comparing the nutritional content of the scanned item with the user's nutritional goals. In some embodiments, where the user's lifestyle plan is also stored on the personal mobile device 120, the analysis and comparison of potential selections may occur completely within the personal mobile device 120. In other embodiments, the personal mobile device 120 communicates with the server 130 to interpret the nutritional information obtained from the RFID tag, to compare the nutritional information with the user's goals, or both. So for example, the user may upload a potential selection to the server 130, where a comparison is made of the selection with the user's lifestyle plan. The lifestyle management software may formulate feedback information, such as a message of approval or an alternative message suggesting that the user make a different selection, and transmit the feedback information to the user's personal mobile device, for example, as a text message.

The person 115 may scan and analyze as many edible items as they wish in order to select one or more edible items for consumption. Following a final selection, the user may mark the consumed items for transmission to the server 130. Transmission to the server 130 may occur immediately, or may be deferred until a later time. In a similar manner, activity data may be uploaded to the server 130.

After receiving a record of consumed food items from the user's personal mobile device 120, the lifestyle management software at the server 130 may store the relevant nutritional information and associate the nutritional information with the user and, for example, a date/time stamp, in the database 135. The lifestyle management software may calculate implications of the food items consumed and any uploaded measures of physical activity for the user's lifestyle plan. A graphical display (such as, for example, a bar graph or pie chart) containing the comparison information may be shown to the user to provide near real-time feedback on lifestyle behavior. Recommendations based on the user's pattern of activity may be displayed to the user, or to the user's health care provided or coach. The user may also later login to their account and review their progress and the impact of their choices.

Embodiments of the present invention may advantageously assist users in making nutritional choices in real-time at the point of decision. These systems may be particularly helpful in some cases for users, such as teenagers, who make frequent use of their personal electronic devices, such as cell phones. Of course, users who do not frequently use their personal electronic devices may also use embodiments of the present invention.

From the foregoing it will be appreciated that, although specific embodiments of the invention have been described herein for purposes of illustration, various modifications may be made without deviating from the spirit and scope of the invention.

What is claimed is:

1. A system for use by a person to evaluate an edible item having a nutritional content and associated with a menu, the system comprising:
an RFID tag associated with the menu and encoded with information regarding at least a portion of the nutritional content of the edible item;
a portable electronic device including an RFID tag reader and a display, the RFID tag reader being configured to obtain the information regarding at least the portion of the nutritional content encoded by the RFID tag and display at least a portion of the obtained information from the RFID tag on the display to aid the person in evaluating the edible item.

2. The system according to claim 1 further comprising:
a computing device storing a lifestyle plan of the person and configured to receive the obtained information from the RFID tag and to compare the received information with the lifestyle plan of the person and transmit feedback information to the portable electronic device based at least in part on the comparison.

3. The system according to claim 2 wherein the feedback information includes a recommendation.

4. The system according to claim 2 wherein the edible item has a number of calories, the lifestyle plan of the person including a daily caloric limit and the information encoded by the RFID tag having the number of calories of the edible item.

5. An electronic device for use by a person and with an RFID tag encoded with nutritional information regarding an edible item on a menu associated with the RFID tag, the electronic device comprising:
an RFID tag reader configured to obtain the nutritional information from the RFID tag; and
a display coupled to the RFID tag reader configured to display the nutritional information to aid the person in evaluating the edible item.

6. The electronic device according to claim 5 further comprising:
a processor coupled to the RFID tag reader and the display;
a memory coupled to the processor and encoded with a plurality of instructions that, when executed, cause the processor to parse the nutritional information from the RFID tag reader in a manner suitable for use by the display.

7. The electronic device according to claim 6 further comprising:
a transmitter coupled to the processor and configured to upload the nutritional information to a computing device;
an input device coupled to the processor for use by the person to select the edible item;
the memory further encoded with instructions that, when executed, cause the processor to upload the nutritional information to the computing device.

8. The electronic device according to claim 7 further comprising:
a receiver configured to receive feedback information from the computing device regarding the edible item based in part on the uploaded nutritional information;
the memory further encoded with instructions that, when executed, cause the processor to respond to the feedback information received from the computing device.

9. The electronic device according to claim 8 wherein the feedback information includes a text message and the encoded instructions cause the processor to read the text message and react to the text message.

10. The electronic device according to claim 8 wherein the processor is configured to react to the text message by causing the display to display an alert message for the person.

11. The electronic device according to claim 8 further comprising an accelerometer coupled to the processor and configured to measure movement of the person, the transmission device further configured to upload the measured movement to the computing device, the receiver configured to receive feedback information from the computing device regarding attainment of activity goals based in part on the measured movement.

12. The electronic device according to claim 11 wherein the measured movement is taken from the group consisting of steps taken by the person and distance traveled by the person.

13. A computer program product for aiding a person in selecting an edible item from a menu associated with an RFID tag encoded with nutritional information regarding the edible item, the computer program product comprising a computer readable memory encoded with a plurality of instructions that, when executed, cause a processor to:
obtain the nutritional information from the RFID tag;
display the nutritional information to the person;
upload the nutritional information to a computing device;
receive feedback information from the computing device based in part on the uploaded information and a lifestyle plan for the person; and
display at least a portion of the feedback information to assist the person.

14. A computer program product for aiding a person in selecting an edible item from a menu of a plurality of edible items associated with an RFID tag encoded with nutritional information regarding the edible item, the computer program product comprising a computer readable memory encoded with a plurality of instructions that, when executed, cause a processor to:
receive nutritional information regarding the edible item;
access a lifestyle plan associated with the person;
compare the received nutritional information with the accessed lifestyle plan; and
transmit feedback information to the person based on the comparison.

15. A computer program product according to claim 14 wherein the transmission of feedback information occurs prior to consumption of the edible item by the person.

16. A computer program product according to claim 14 wherein the plurality of instructions further cause the processor to receive information regarding activity of the person and wherein the feedback information is further based on the activity of the person.

17. A computer program product according to claim 14 wherein the lifestyle plan includes a daily calorie count, and the received nutritional information includes a number of calories associated with the edible item.

18. A system for aiding a person in selecting from among a plurality of edible items associated with one or more RFID tags encoded with nutritional information regarding the edible items, the system comprising:
a database storing a lifestyle plan for the person and lifestyle plans for other persons;
a receiver configured to receive from the person nutritional information stored on the one or more RFID tags pertaining to one of the plurality of edible items;
a processor coupled to the receiver and configured to access the lifestyle plan for the person, compare the lifestyle plan with the received nutritional information and formulate feedback information;
a transmitter coupled to the processor and configured to transmit the feedback information to the person.

19. The system according to claim 18 wherein the transmitter is configured to transmit the feedback information to the person in a text message.

20. The system according to claim 18 wherein the transmitter is configured to transmit the feedback information to the person in an email.

21. The system according to claim 18 further comprising:
a memory coupled to the processor configured to store nutritional information received from the person and an association between the person and the stored nutritional information such that the person may later access the stored nutritional information.

22. A method for use by a person in proximity to an RFID tag to comply with a lifestyle plan, the RFID tag associated with a menu having a plurality of edible items and having nutritional information with respect to at least one of the plurality of edible items, the method comprising:
scanning the RFID tag to obtain nutritional information for at least one of the plurality of edible items;
uploading the nutritional information to a lifestyle management server;
receiving feedback information from the lifestyle management server based on a comparison of the lifestyle plan with the nutritional information; and
selecting the at least one of the plurality of edible items for consumption based in part on the feedback information.

23. A method according to claim 22 wherein the displaying step includes displaying a graph illustrating a comparison between at least one aspect of the lifestyle plan and an aspect of the nutritional information.

24. A method according to claim 22 further comprising:
obtaining a measure of physical activity of the person; and
uploading the measure of physical activity to the lifestyle management server;
wherein the receiving step includes receiving feedback information based at least in part on the measure of physical activity.

25. A method according to claim 22 wherein the receiving step occurs prior to the consuming step.
